(19) United States
(12) Patent Application Publication
(10) Pub. No.: US 2019/0280846 A1
(43) Pub. Date: Sep. 12, 2019

(54) Full-Duplex Switching Module And Method

(71) Applicant: TE Connectivity Nederland BV, S'Hertogenbosch (NL)

(72) Inventors: Mohadig Widha Rousstia, Eindhoven (NL); Rohit Sharma, Eindhoven (NL); Gied Habraken, Valkenswaard (NL)

(73) Assignee: TE Connectivity Nederland BV, S'Hertogenbosch (NL)

(21) Appl. No.: 16/421,688

(22) Filed: May 24, 2019

Related U.S. Application Data
(63) Continuation of application No. PCT/EP2017/080080, filed on Nov. 22, 2017.

(30) Foreign Application Priority Data
Nov. 24, 2016 (EP) 16200554.0

(51) Int. Cl. H04L 5/14; H01P 1/15

(52) U.S. Cl. CPC H04L 5/143; H01P 1/15

(57) ABSTRACT

A switching module for establishing a controllable propagation path for a high-frequency modulated signal in response to a switching information comprises a controllable switch and a link-management unit. The controllable switch is adapted to couple a first port to one of a second port and a third port. The link-management unit is operable to generate a control signal for controlling the switch based on the switching information. The link-management unit has a detector unit adapted to receive the control signal with the high-frequency modulated signal and to generate a pulse for controlling the switch depending on the control signal.

### CROSS-REFERENCE TO RELATED APPLICATIONS

This application is a continuation of PCT International Application No. PCT/EP2017/080080, filed on Nov. 22, 2017, which claims priority under 35 U.S.C. § 119 to European Patent Application No. 16200554.0, filed on Nov. 24, 2016.

### FIELD OF THE INVENTION

The present invention relates to a switching module and, more particularly, to a switching module for establishing a controllable propagation path for a high-frequency modulated signal in response to switching information.

### BACKGROUND

Switching signals that are transmitted via millimeter wave signals can be used with polymer millimeter wave fibers (PMF, also referred to herein as plastic waveguides). The millimeter wave frequency range refers to signals with a frequency between 30 GHz and 300 GHz, for instance 60 GHz. By making use of carrier frequencies in this frequency domain, wide band communication systems benefit from the large bandwidth available. Plastic waveguides are often used in transmitting these millimeter wave carriers over a distance of several meters to provide a Gbps communication link because wireless transmission in this frequency range suffers from increased free space path-loss. Plastic waveguides benefit from the low inherent transmission loss of the polymer in the millimeter wave frequency domain. Plastic waveguides, consequently, provide a low loss, cost friendly, and lightweight guided channel.

When switching signals are transmitted via plastic fibers/waveguides to predetermined destinations, it is important that a switching device receiving the signal processes the information regarding which particular destination the signal is bound to switch. Conventional switching systems use address information that is encoded in a header of data packets containing the payload information as a data filed. The address information has to be decoded and processing of this information is performed not in the physical layer, but in a higher communication layer.

Furthermore, large network switching systems use lookup tables which need to be updated and require a certain degree of complexity in the electronic circuits of the switching system. Hence, the delay in data communication in such systems is increased to an often unacceptable level.

There is a need to provide a switching module and a corresponding method for establishing a controllable propagation path for a high-frequency modulated signal that has a low latency, can be realized at low cost, and that is robust and reliable even under harsh environmental conditions.

### SUMMARY

A switching module for establishing a controllable propagation path for a high-frequency modulated signal in response to a switching information comprises a controllable switch and a link-management unit. The controllable switch is adapted to couple a first port to one of a second port and a third port. The link-management unit is operable to generate a control signal for controlling the switch based on the switching information. The link-management unit has a detector unit adapted to receive the control signal with the high-frequency modulated signal and to generate a pulse for controlling the switch depending on the control signal.

### BRIEF DESCRIPTION OF THE DRAWINGS

The invention will now be described by way of example with reference to the accompanying Figures, of which:

FIG. 1 is a schematic diagram of a switching module according to an embodiment;

FIG. 2 is a schematic diagram of a control signal generating unit according to an embodiment;

FIG. 3 is a schematic diagram of the switching module; and

FIG. 4 is a schematic diagram of a detector unit of the switching module.

### DETAILED DESCRIPTION OF THE EMBODIMENT(S)

The accompanying drawings are incorporated into the specification and form a part of the specification to illustrate several embodiments of the present invention. These drawings, together with the description, serve to explain the principles of the invention. The drawings are merely for the purpose of illustrating the exemplary embodiments of how the invention can be made and used, and are not to be construed as limiting the invention to only the illustrated and described embodiments.

Furthermore, several aspects of the embodiments may form—individually or in different combinations—solutions according to the present invention. Further features and advantages will become apparent from the following more particular description of the various embodiments of the invention as illustrated in the accompanying drawings, in which like references refer to like elements.

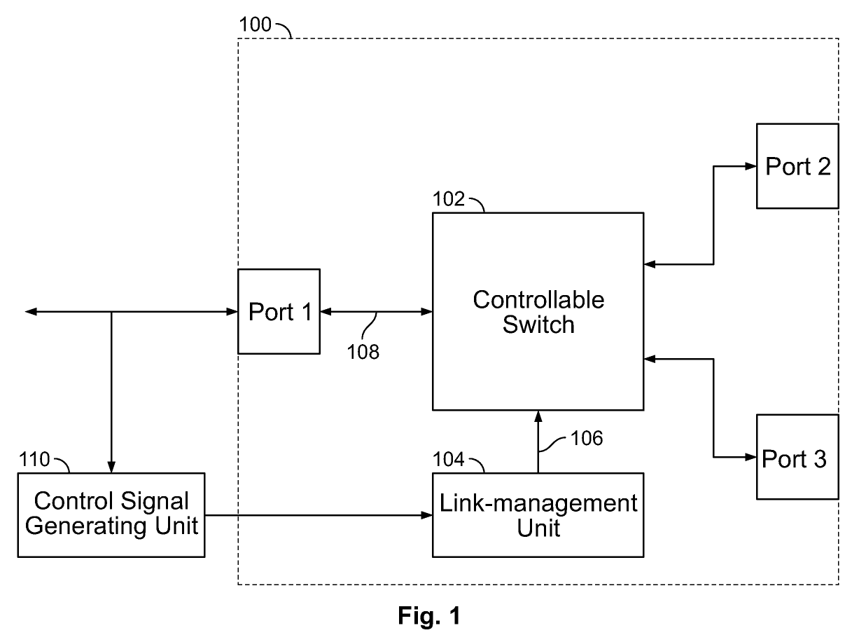

A switching module 100 according to an embodiment is shown in FIG. 1. In the most basic architecture, the switching module 100 establishes a controllable propagation path for a high-frequency modulated signal 108 from port 1 either to port 2 or to port 3. A control signal for controlling the selection of the propagation path is generated by an external control signal generating unit 110.

The high-frequency modulated signal 108 refers to a millimeter wave signal, i.e. to signals with a frequency between 30 GHz and 300 GHz, for instance 60 GHz. This frequency is not altered when gating the signal through the switching module 100; no up or down conversion is needed.

The physical gating function is performed by a controllable switch 102 shown in FIG. 1. The controllable switch 102 may, for instance, comprise a GaAs monolithic microwave integrated circuit (MMIC) switch. Such MMIC switches are available in chip sizes of only several thousand square micrometers and therefore allow a particularly space-saving overall design of the switching module 100. Although FIG. 1 only shows a controllable propagation path between one port 1 on one side of the switch 102 and two selectable ports 2, 3 on the other side of the switch 102, it is clear for a person skilled in the art that any other constellation may of course also be covered by the present invention. The switch 102 may, for instance, be able to establish a propagation path between more than two selectable ports on each side.

For controlling the controllable switch 102, as shown in FIG. 1, the switching module 100 further comprises a link-management unit 104. As shown in FIG. 1, the link-management unit 104 is connected to port 1 and receives the high-frequency modulated signal that is input at port 1 for extracting the control signal therefrom. Based on the extracted control signal, the link management unit 104 generates a switching pulse 106 that controls the controllable switch 102 to connect port 1 either to port 2 or to port 3. According to the present invention, the link-management unit 104 does not perform any decoding on the high-frequency modulated signal 108, but derives the control information by a latching circuit and a detecting unit, as shown and described in the following figures.

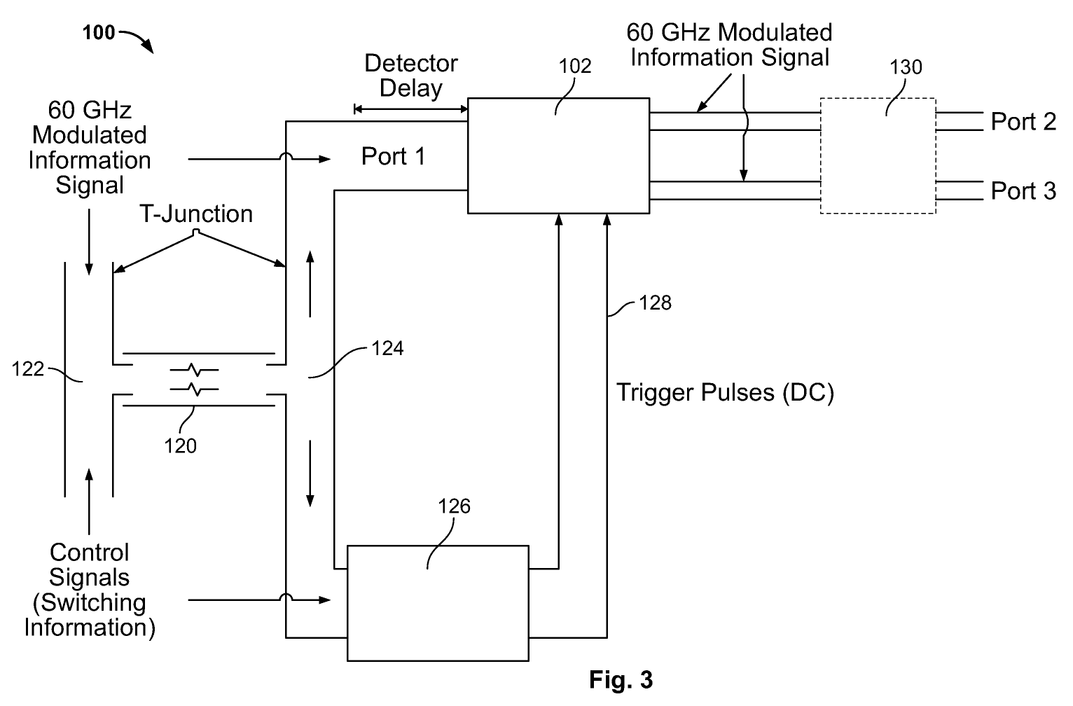

The control signal generating unit 110, as shown in FIG. 1, is provided externally to the switching module 100. The control signal generating unit 110 generates the control signal from a device (such as a switch control or a microcontroller in a signal source, when considering the switching module as the signal sink) and informs the switching module 100 to indicate a correct port to which the signal has to be switched. This generated control signal is interpreted in the link-management unit 104 of the switching module 100, in particular by the detector unit 126 shown in FIG. 3.

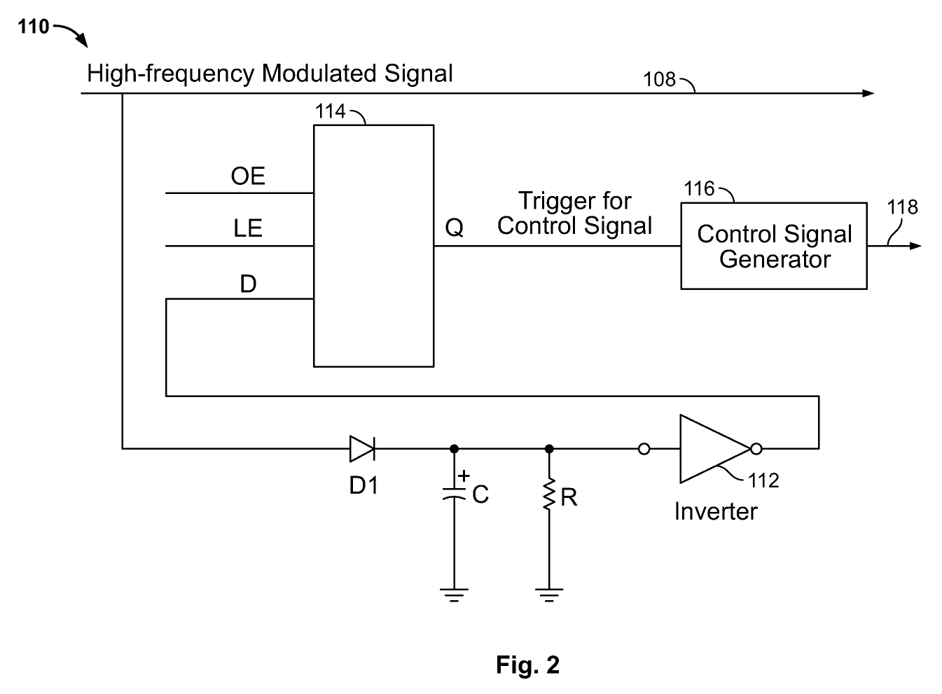

As shown in FIG. 2, the control signal generating unit 110 is connected to the high-frequency modulated signal which is input via a diode D1 and an inverter 112 into the data input terminal D of a latch circuit 114. The latch circuit 114 may, for instance, be formed by a commercially available integrated circuit, such as the SN74LVC1G373 single D-type latch from Texas Instruments. It is of course clear for a person skilled in the art that any other suitable latch circuit may also be used in the control signal generating unit 110 according to the present invention. The latch circuit 114 comprises a latch enable terminal LE and an output and enable terminal OE. While the latch enable input LE is high, the Q output follows the data input at the data terminal D. When LE is taken low, the Q output is latched at the logic level set up by the D input.

The control signal generating unit 110 is thereby able to generate a control signal which contains the address information. By providing respective enable signals, the control signal can be generated at a particular timeslot where the high-frequency modulated signal has to be switched. The latch circuit introduces a delay of about 4 ns, thus causing only a minimal latency. The address information can be transmitted and evaluated in the physical layer domain without the need to transform it into a higher layer domain. Furthermore, no higher layer decoding and addressing structures and no look-up tables need to be provided.

A control signal generator 116 of the control signal generating unit 110, shown in FIG. 2, provides the actual control signal 118, for instance a pulse having a predetermined frequency different from the frequency of the high-frequency modulated signal. The control signal 118 generated by the control signal generator 116 may be transmitted to the link management unit 104 via the same PMF as the high-frequency modulated signal. Alternatively, the control signal 118 may also be received by the link-management circuit 104 via a wireless channel.

In an embodiment of the switching module 100 shown in FIG. 3, the control signal responsible for the switching to a particular port can be dynamically allotted. The 60 GHz modulated information signal is input simultaneously with the control signal into a PMF 120 at a first T-junction 122. The PMF 120 transmits both the control signals and the high-frequency modulated signal. The transmitted signal, via a second T-junction 124, is input into the controllable switch 102 and into a detector unit 126. The detector unit 126 extracts control signal from the received input and generates DC trigger pulses 128 that cause the controllable switch 102 to switch to either port 2 or to port 3. Accordingly, a propagation path is established between port 1 and one of the ports 2 or 3. This propagation path allows a full-duplex communication. An optional second detector unit 130 may be provided to extract second control signals transmitted with a second high-frequency modulated signal from port 2 and/or port 3 with the signal flow being directed towards port 1.

In an embodiment, the switching module 100 comprises fiber coupling antennas for coupling the PMF 120 to each of the first 1, second 2, and third 3 ports. The switching module 100 may further comprise a power amplification device adapted to amplify the high-frequency modulated signal. A signal that has intensity loss can be refreshed when passing through the switching module 100.

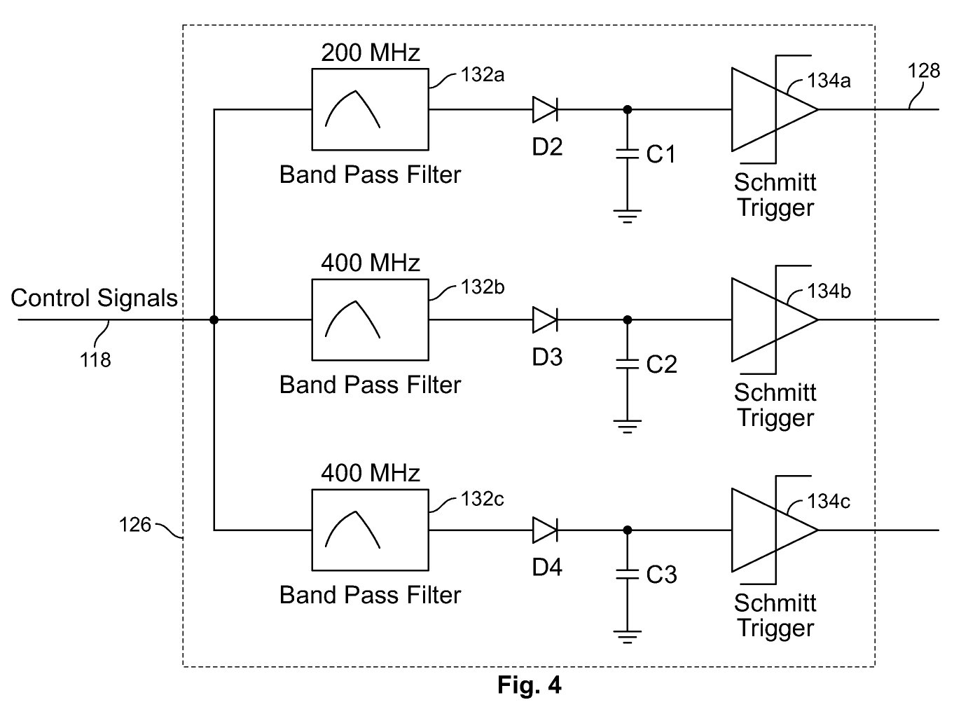

The detector unit 126, as shown in FIG. 4, is able to extract control signals 118 which are formed by a frequency encoded pulses. For instance, a pulse having a frequency of 200 MHz signifies a switching to port 2, whereas a pulse having a frequency of 400 MHz signifies switching to port 3. Band pass filters 132 extract the respective control signal and input it via a diode into a Schmitt trigger 134. Each of the Schmitt triggers 134 outputs a DC trigger pulse 128 when the respectively frequency encoded control signal detected at the input of the detector unit 126. Capacitors C1 to C3 stabilize the input for the Schmitt triggers 134a to 134c. In another embodiment, a time division coding or code division coding may be employed; the control signal may be generated as a frequency multiplexed, a time multiplexed, or a code multiplexed signal. The high-frequency modulated signal does not have to be transformed or demodulated in order to extract the address information that is provided to the controllable switch 102, but stays unaltered in its carrier frequency without down or up conversion.

What is claimed is:

1. A switching module for establishing a controllable propagation path for a high-frequency modulated signal in response to a switching information, comprising:
a controllable switch adapted to couple a first port to one of a second port and a third port; and
a link-management unit that is operable to generate a control signal for controlling the switch based on the switching information, the link-management unit has a detector unit adapted to receive the control signal with the high-frequency modulated signal and to generate a pulse for controlling the switch depending on the control signal.

2. The switching module of claim 1, further comprising a control signal generating unit having a latch circuit with a data input terminal, a latch enable terminal, and an output terminal.

3. The switching module of claim 2, wherein the high-frequency modulated signal is input into the data input terminal.

4. The switching module of claim 3, wherein the output terminal is connected to a control signal generator for generating the control signal.

5. The switching module of claim 1, wherein the switch has a GaAs monolithic microwave integrated circuit.

6. The switching module of claim 1, wherein the detector unit has a first band pass filter and a second band pass filter receiving the control signal.

7. The switching module of claim 6, wherein the detector unit has a first Schmitt trigger connected to an output of the first band pass filter and adapted to generate a trigger pulse in response to an output signal present at the output of the first band pass filter.

8. The switching module of claim 7, wherein the detector unit has a second Schmitt trigger connected to an output of the second band pass filter and adapted to generate a trigger pulse in response to an output signal present at the output of the second band pass filter.

9. The switching module of claim 1, further comprising a second detector unit adapted to detect a second control signal transmitted with a second high-frequency modulated signal received at the second or third port.

10. The switching module of claim 9, wherein the propagation path is a full-duplex transmission path.

11. The switching module of claim 1, further comprising a fiber coupling antenna coupling a millimeter wave conducting fiber to each of the first port, the second port, and the third port.

12. The switching module of claim 1, wherein the control signal includes a plurality of pulses with different frequencies for encoding the switching information.

13. The switching module of claim 1, further comprising a power amplification device adapted to amplify the high-frequency modulated signal.

14. A method of establishing a controllable propagation path for a high-frequency modulated signal in response to a switching information, comprising:
generating a control signal for controlling a controllable switch based on the switching information;
transmitting the control signal together with the high-frequency modulated signal;
generating a pulse for controlling the switch depending on the control signal; and
coupling a first port to one of a second port and a third port with the controllable switch.

15. The method of claim 14, wherein generating the pulse comprises filtering the control signal and inputting the filtered control signal into a trigger, the trigger generates the pulse.

16. The method of claim 14, wherein the control signal is generated from the switching information transmitted with the high-frequency modulated signal over a millimeter wave fiber.

17. The method of claim 14, wherein the control signal is generated from the switching information transmitted simultaneously with the high-frequency modulated signal over a wireless channel.

18. The method of claim 14, wherein the control signal is generated as a frequency multiplexed or a code multiplexed signal.

19. The method of claim 14, wherein the controllable propagation path is a full-duplex transmission path.
